(19) United States
(12) Patent Application Publication
(10) Pub. No.: US 2011/0129608 A1
(43) Pub. Date: Jun. 2, 2011

(54) METHODS OF APPLYING MATRIX RESINS TO GLASS FIBERS

(76) Inventors: Leonard J. Adzima, Pickerington, OH (US); Charles F. Pratt, Gig Harbor, WA (US); Olivier Debeurme, Paris (FR)

(21) Appl. No.: 12/627,508

(22) Filed: Nov. 30, 2009

(51) Int. Cl. B05D 3/10

(52) U.S. Cl. 427/301

(57) ABSTRACT

Methods of forming composite rovings formed of reinforcing fibers coated with at least one matrix resin are provided. The matrix resin may be any thermoplastic or thermoset powder or thermoplastic or thermoset emulsion, and is applied to reinforcement fibers after a size composition has been applied. The matrix resin may be applied to the reinforcing fiber in an amount from about 20 to about 35% by weight of the composite fiber. The fibers travel a distance sufficient to dry the size and the matrix resin. In exemplary embodiments, the distance may be from about 20 to about 150 feet. A heating apparatus may be utilized to assist in drying the fibers. The end composite fiber product is a composite roving that is formed in one step during the glass forming process and can be used in further processing steps to form composite parts without the need to add additional resin.

### TECHNICAL FIELD AND INDUSTRIAL APPLICABILITY OF THE INVENTION

The present invention relates generally to reinforcing fiber materials for composite articles, and more particularly, to methods of applying at least one matrix resin to a reinforcing fiber during the glass forming process to form a composite fiber.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. Glass fibers are commonly used as reinforcements in polymer matrices to form glass fiber reinforced plastics or composites because they provide dimensional stability as they do not shrink or stretch in response to changing atmospheric conditions. In addition, glass fibers have high tensile strength, heat resistance, moisture resistance, and high thermal conductivity. It is known in the art that glass fiber reinforced polymer composites possess higher mechanical properties compared to unreinforced polymer composites, provided that the reinforcement fiber surface is suitably modified by a sizing composition. Thus, better dimensional stability, tensile strength and modulus, flexural strength and modulus, impact resistance, and creep resistance may be achieved with glass fiber reinforced composites.

Chopped glass fibers are commonly used as reinforcement materials in reinforced composites. Conventionally, glass fibers are formed by attenuating streams of a molten glass material from a bushing or orifice. An aqueous sizing composition, or chemical treatment, commonly containing lubricants, coupling agents, and film-forming binder resins, is applied to the glass fibers after they are drawn from the bushing. The sizing composition provides protection to the fibers from interfilament abrasion and promotes compatibility between the glass fibers and the matrix in which the glass fibers are to be used.

The attenuated fibers travel a distance to a gathering shoe where the wet, sized fibers may be split, gathered into strands, and wound onto a collet into forming packages or cakes. Conventionally, the distance between the bushing and the gathering shoe is about 5 to about 15 feet. The forming cakes are heated in an oven at a temperature from about 212° F. to about 270° F. for approximately 15 to 20 hours to remove water and cure the size composition on the surface of the glass fibers. After the fibers are dried, the strands may be transported to a chopper where the fibers are chopped into chopped strand segments. The chopped strand segments may be mixed with a polymeric resin and supplied to a compression- or injection-molding machine to be formed into glass fiber reinforced composites. Such a process is referred to as an “off-line” process because the fibers are dried and chopped after the glass fibers are formed. In addition, the process is considered a “two-step” process because the matrix resin must be separately supplied to the glass fibers to form a glass fiber/resin mixture which is then processed, such as by heat, to melt the resin and disperse the fibers throughout the composite product.

Alternatively, the dried glass strands may be coated off-line with a matrix resin, such as a water-based solution containing an epoxy powder or a polypropylene solid dispersion, and wound into a package for later use. These coated strands may be converted into a charge and compression molded to form a composite article having a substantially even dispersement of fibers. This is a two-step process in that (1) the glass must be made, dried, and gathered into strands, and (2) the strands are off-line coated with a matrix resin and dried to remove any water from the matrix resin solution.

Composites are typically made by introducing glass, or other reinforcing fibers, to a thermoplastic or thermosetting polymer material. The glass fiber and polymer material are mixed together and formed into a composite part in a wide variety of methods, including compression and injection molding.

Many problems exist with the existing technologies used to make composite parts and with the composites themselves. For example, the thermoplastic or thermosetting polymer materials commonly used in these systems are solvent-based systems. As a result, volatile organic compounds (VOC's) may be released into the atmosphere as the part is cured.

Additionally, in conventional compression and injection molding processes, the resin and the glass fibers are generally combined in a separate step prior to molding, which adds to the manufacturing costs. Further, the amount of fiber content that may be introduced in injection and compression molding processes is limited due to the process itself, as is known in the art. Because conventional molding processes contain a lower fiber content and because matrix resins are more generally expensive than the reinforcement fibers, the cost of the composite part is increased.

Although the current off-line, two-step processes form suitable and marketable end products, the off-line processes are time consuming not only in that the forming and chopping, or forming and matrix application, occurs in two separate steps, but also in that it requires extensive, lengthy drying times to fully cure the size composition. Thus, there exists a need in the art for a cost-effective and efficient process that completes the product fabrication in continuous steps with the glass fabrication process in a shorter period of time. There also exists a need in the art for the simplification of the formation of molded composite parts.

### SUMMARY OF THE INVENTION

It is an object of the present invention to provide an in-line method of making a composite roving that may subsequently be used to make structural composite parts. In at least one exemplary embodiment, a sizing composition is applied to attenuated glass fibers. At least one matrix resin is applied to the sized glass fibers by a suitable applicator in an amount from about 20 to about 35% by weight of the composite roving. The high loading of the matrix resin on the glass fibers permits the formation of a composite fiber that does not require a separate application of additional matrix resins to form a final composite product. The matrix resin may be a thermoplastic powder, a thermoset powder, a thermoplastic emulsion, and/or a thermoset emulsion. The glass fiber having thereon the size composition and matrix resin(s) is then permitted to travel a distance that is sufficient to at least partially dry both the size and matrix resin onto the glass fibers. It is envisioned that the distance may be up to or even greater than 150 feet. Exemplary embodiments may include distances greater than about 20 feet, from about 20 to about 150 feet, from about 25 to about 100 feet, or from about 50 to about 100 feet. A heating apparatus may be utilized to assist in further drying the fibers to a moisture content of less than about 1% free water (i.e., a removal of at least about 99% of the free water). The heating apparatus should be maintained at a temperature hot enough to remove the water from the matrix resin coating but cool enough to prevent the matrix resin coating from significant melting. A cooling device may optionally be utilized to cool the fibers prior to gathering the fibers into strands and then into a composite roving. The composite roving may be wound or chopped for later use. In either situation, the composite roving may be processed into molded high performance composite parts.

It is another object of the present invention to provide a one step method of making a composite roving. In at least one exemplary embodiment, a size composition is applied to attenuated glass fibers. The sized glass fibers are split into strands, which then pass a resin applicator where one or more matrix resins are applied to the strands. In this embodiment, the matrix resin substantially surrounds the external portion of the strand and leaves the internal, sized fibers untouched or virtually untouched by the matrix resin. The matrix resin(s) may be applied to the strands in an amount from about 20 to about 35% by weight of the composite roving. The matrix resin may be a thermoplastic powder, a thermoset powder, a thermoplastic emulsion, and/or a thermoset emulsion. After the application of the matrix resin, the strand having thereon the size composition and matrix resin(s) travels a distance sufficient to at least partially dry the size and matrix resin onto the glass strands. A heating apparatus may be utilized to assist in further drying the strands to a moisture content of less than about 1% free water (i.e., a removal of at least about 99% of the free water from the strands). A cooling device may optionally be utilized to cool the strands prior to gathering the strands into a composite roving. The composite roving may be wound or chopped for later use.

It is yet another object of the present invention to provide a method of forming a structural composite part. In one or more exemplary embodiments, a composite roving is formed by one of the methods described herein. Chopped segments formed by chopping the composite roving may be made into a preform and compression molded into a structural composite having a desired shape. Due to the inclusion of the matrix resin in the composite roving, the composite part may be molded into the desired shape without having to add any additional resin to the mold.

It is an advantage of the present invention that composite parts can be formed that have a high fiber content from about 65 to about 80% by weight.

It is also an advantage of the present invention that the matrix resin is applied to the glass fiber in a one step process during the glass formation process.

It is another advantage of the present invention that manufacturing and raw material costs are reduced.

It is yet another advantage of the present invention that the composition of the final composite part can be controlled due to the matrix resin being present on the glass fiber.

It is a feature of the present invention that at least one matrix resin is present in the composite roving.

It is a feature of the present invention that the aesthetic properties of the final composite part can be controlled by adding dyes or colored powders to the emulsion or slurry containing the matrix resin.

It is another feature of the present invention that the matrix resin may be applied to the fiber in an amount from about 20 to about 35% by weight.

It is another feature of the present invention that the composite parts formed by the present invention have high mechanical properties due to the high glass fiber content in the composite.

It is yet another feature of the present invention that the composite rovings can be utilized in molding processes without added resin to form a final composite part.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a processing line for forming a composite roving according to one exemplary embodiment of the invention in which the composite roving is chopped;

FIG. 2 is a schematic illustration of the processing line of FIG. 1 except that the composite roving is wound for storage;

FIG. 3 is a schematic illustration of a processing line for forming a composite roving according to a second exemplary embodiment of the present invention in which the composite roving is chopped;

FIG. 4 is a schematic illustration of the processing line of FIG. 3 except that the composite roving is wound for storage;

FIG. 5 is a schematic illustration of a method for making preform to be utilized the compression molded process illustrated in FIG. 6;

FIG. 6 is a schematic illustration of a compression molding process according to one aspect of the present invention for forming a composite molded product that has a high glass content; and

FIGS. 7A-7C are schematic illustrations of weaving patterns that can be formed from the composite roving material.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “size”, “size composition”, and “sizing composition” may be used interchangeably herein.

The present invention relates to methods for the application of one or more matrix resins onto a reinforcing fiber. The result is a composite fiber that includes at least one matrix resin. The matrix resin may be any thermoplastic or thermoset powder or emulsion and is applied after the size composition has been applied to the reinforcement fibers. The matrix resin may be applied to the reinforcing fiber in an amount from about 20 to about 35% by weight of the composite fiber. The end fiber product formed by the processes of the present invention is a composite roving that is formed in one step during the glass forming process and can be used in further processing steps to form composite parts without the need to add additional resin.

Suitable reinforcing fibers that may be used in the present invention should be thermally stable, and may be any type of glass fiber, such as A-type glass fibers, C-type glass fibers, E-type glass fibers, S-type glass fibers, ECR-type glass fibers (e.g., Advantex® glass fibers commercially available from Owens Corning), wool glass fibers, or combinations thereof. The use of other reinforcing fibers such as natural fibers, mineral fibers, carbon fibers, ceramic fibers, and/or synthetic fibers such as polyester, polyethylene, polyethylene terephthalate, polypropylene, polyamide, aramid, and/or polyaramid fibers are considered to be within the purview of the invention. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof. In exemplary embodiments, the fiber is a glass fiber, and more preferably, Advantex® glass fibers.

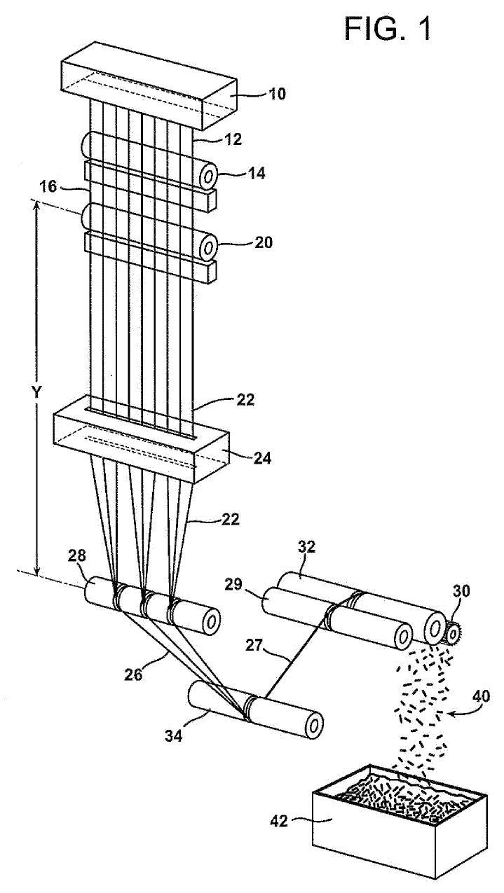

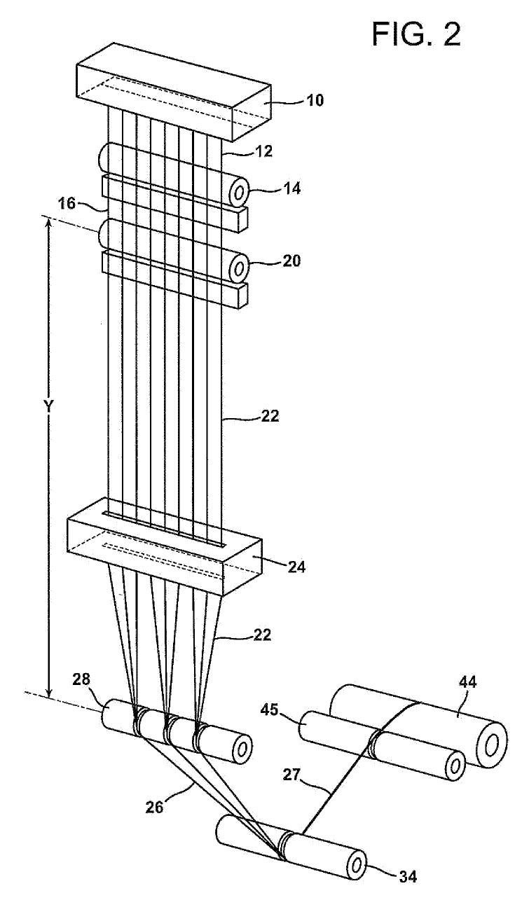

Turning to FIGS. 1 and 2, glass fibers 12 may be formed by attenuating streams of a molten glass material (not shown) from a bushing 10. It is to be appreciated that glass fibers 12 are described herein with respect to the exemplary embodiments, although any of the aforementioned reinforcement fibers may be utilized. The attenuated glass fibers 12 may have diameters from about 8 to about 23 microns, preferably from about 13 to about 22 microns. After the glass fibers 12 are drawn from the bushing 10, an aqueous sizing composition is applied to the fibers 12. The sizing composition may be applied by conventional methods such as by the application roller 14 shown in FIG. 1 to achieve a desired amount of the sizing composition on the fibers 12. Other conventional application methods including kiss roll, dip-draw, slide, or spray application may alternatively be utilized. The size composition is preferably applied to the fibers in an amount sufficient to provide the fibers with a moisture content from about 8% to about 12%. The size protects the glass fibers 12 from breakage during subsequent processing, helps to retard interfilament abrasion, and ensures the integrity of the strands of glass fibers, e.g., the interconnection of the glass filaments that form the strand.

The size composition applied to the glass fibers 12 includes one or more film forming agents (such as a polyurethane film former, a polyester film former, and/or an epoxy resin film former), at least one lubricant, and at least one coupling agent (desirably a silane coupling agent such as an aminosilane or methacryloxy silane coupling agent). Film formers create improved adhesion between the glass fibers 12, which results in improved strand integrity. The film former also acts as a polymeric binding agent to provide additional protection to the glass fibers 12 and improves processability of the glass fibers 12, such as a reduction in fuzz generated by high speed chopping. Silane coupling agents enhance the adhesion of the film forming polymer to the glass fibers and reduce the level of fuzz, or broken fiber filaments, during subsequent processing. The lubricant facilitates manufacturing and reduces fiber-to-fiber abrasion. When needed, a weak acid such as acetic acid, boric acid, metaboric acid, succinic acid, citric acid, formic acid, and/or a polyacrylic acid may be added to the size composition to assist in the hydrolysis of the silane coupling agent.

The size composition further includes water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the size composition may contain up to about 99% water. The size composition may be applied to the fibers 12 with a Loss on Ignition (LOI) of from approximately 0.05% to approximately 1.0% on the dried fiber. LOI may be defined as the reduction in weight experienced by the fibers after heating them to a temperature sufficient to burn or pyrolyze the organic size from the fibers. As used in conjunction with this application, LOI may be defined as the percentage of organic solid matter deposited on the reinforcement fiber surfaces.

After the size composition has been applied to the glass fibers 12, at least one matrix resin is applied to the sized glass fiber 16 (i.e., wet, unbundled fiber) prior to being gathered into a bundle, as is discussed in detail below. The matrix resin may be a thermoplastic powder, a thermoset powder, a thermoplastic emulsion, a thermoset emulsion, and combinations thereof. The thermoset powdered polymer material should be capable of melting, flowing, and curing upon the application of heat as it is molded into a final composite part. The thermoplastic plastic powdered polymer material should be capable of melting, flowing and setting or hardening as it is cooled and molded into a final composite part. There are many different matrix resins that may be used in the present invention, including epoxy resins, polyesters, polypropylene, polyethylene, polyamides, polyethylene terephthalate (PET), bisphenol type epoxies, novalac type epoxies, phenolics, acrylics, polyurethanes, hybrid polymers such as, for example, an epoxy polyester copolymer or a polyester triglycidylisocyanurate copolymer, and other thermosetting or thermoplastic polymers that exhibit good wetting and processibiltiy for making a composite part. In exemplary embodiments, the thermoset matrix resin is an epoxy resin and the thermoplastic matrix resin is polypropylene.

An emulsion containing the thermoplastic or thermoset resin may be added to the sized glass fibers 16 by an application roller 20 to form a composite fiber 22. Other conventional application methods, such as kiss roll, dip-draw, slide, or spray application may be used to apply the matrix resin to the size glass fibers 16. Alternatively, a powdered thermoset or thermoplastic resin may be premixed with water and, optionally, suitable surfactants to form a slurry. The resin slurry may also contain film formers that aid in attaching the powdered resin to the fibers and/or additives that aid in dispersing the powdered resin in the film former. The slurry containing the powdered thermoset or thermoplastic resin may then be applied to the sized glass fibers 16 by any conventional application method, such as, but not limited to those described above. It is desirable to evenly or substantially evenly coat the sized glass fibers 16 with the emulsion or slurry. In exemplary embodiments, sized Advantex® fibers are coated with an epoxy resin or a polypropylene resin to form the composite fiber 22 and then form a high performance composite roving.

The matrix resin is applied to the sized glass fiber 16 in an amount from about 20 to about 35% by weight of the composite roving 27, desirably from about 25 to about 30% by weight, and most desirably, about 25% by weight. The high loading of the matrix resin on the glass fibers permits the formation of a composite fiber 22 that does not require a separate application of additional matrix resins to form a final composite product. For example, the inventive composite fiber can be converted to a charge and compression molded without adding any additional resin. As a result of the high resin content on the sized fiber 16, a higher glass content (e.g., up to approximately 80% glass) in the final composite part is achieved. In exemplary embodiments, the glass content in the final composite part may be from about 65 to about 80% by weight of the composite part, preferably from about 70 to about 75% by weight, and most preferably about 75% by weight. It is well-known in the art that higher glass content results in improved mechanical and reinforcement properties in the final composite parts. Heretofore, such high glass contents in most reinforced composite products have been difficult, if not impossible, to achieve.

The composite fiber 22 containing the matrix resin(s) travels a distance sufficient to at least partially dry both the size and matrix resin onto the glass fibers 12. The distance (Y) from the matrix applicator 20 to the gathering or splitting device 28 is a distance that is sufficient to dry the size composition and matrix resin on the fibers to an extent that the composite fiber will not stick to the gathering shoe 28. It is envisioned that this distance may be up to or greater than about 150 feet. Exemplary embodiments may include distances greater than about 20 feet, from about 20 to about 150 feet, from about 25 to about 100 feet, or from about 50 to about 100 feet. In one or more embodiments, the distance may be from about 30 to about 70 feet. The distance (Y) will be dependent on the content of water in the size composition and in the matrix resin emulsion or slurry, as well as the type and location of the heater positioned in the forming line within the distance (Y).

In exemplary embodiments, greater than (or equal to) about 99% of the free water (i.e., water that is external to the composite fibers 22) is removed, leaving the composite fibers with less than about 1% free water. It is desirable, however, that substantially all of the water is removed prior to winding or chopping the roving 27. It should be noted that the phrase “substantially all of the water” as it is used herein is meant to denote that all or nearly all of the free water from the composite fibers 22 is removed (i.e., <0.05%). For instance, if the emulsion or slurry on the composite fiber 22 is not sufficiently dry, the emulsion or slurry containing the matrix resin will be scraped off the sized fiber 16 when the composite fibers 22 and/or the strand 26 hits contact points such as the gathering shoe 28, roll 35 and roller 34. In an exemplary embodiment, substantially all the water is removed from composite fibers 22 and/or the strand 26 before composite fibers 22 and/or the strand 26 touch such a contact point. It is also envisioned that the composite fibers 22 may simply be air dried by permitting the fibers to travel a distance sufficient to air dry the fibers. It is to be appreciated that this distance may be significantly greater than 150 feet.

A heating apparatus 24 may be positioned between the matrix resin applicator 20 and the gathering/splitting device 28 to assist in drying the composite fiber 22. The positioning of the heating apparatus in the forming line is not critical, and may be located at any position between the matrix resin applicator 20 and the gathering shoe 28. The heating apparatus 24 should be maintained at a temperature hot enough to remove the water from the matrix resin coating but cool enough to prevent the matrix resin coating from significant melting. Non-limiting examples for the heating apparatus 24 include a clam shell type heater, a dielectric heater, an infrared heater, and a fan blowing hot air across the fibers 22. It is considered to be within the purview of the invention to include a cooling device (not illustrated), such as a cooling fan, in the glass forming line prior to any contact points to blow air across the fibers and further cool and/or further dry the composite fibers 22 and the matrix resin prior to gathering the fibers 22. Specifically, the cooling device would be positioned between the heater 24 and the gathering shoe 28.

After the composite fibers 22 are dry or are substantially dry, the composite fibers 22 are gathered into strands 26 (i.e., bundles of individual sized/resin coated fibers 22) by the gathering shoe 28 and then into a roving 27 by roller or idler 34. The specific number of individual fibers present in the strands 26 is predetermined and will vary depending on the particular application and desired final end product. In some embodiments, the strands 26 contain between approximately 50 and 1000 (or more) composite fibers 22. Additionally, although FIGS. 1-4 depict the formation of three individual strands 26 to form the composite roving 27, it is to be appreciated that the present invention is not restricted to the formation of three strands 26. The inclusion of a greater or lesser number of strands 26 is considered to be within the purview of the invention. In exemplary embodiments, the number of strands may vary from 100-500 (or more).

The roving 27 formed by strands 26 may be wound or chopped for later use. In FIG. 1, the roving 27 is passed from roller 34 to a guide roller 29 and into a cutting apparatus such as a chopper 30/cot 32 combination where the roving 27 is chopped into chopped strand segments 40 having a length from about ¼ to about 2.0 inches, preferably from about ½ to about 1.0 inch. The chopped strand segments 40 are collected in a container 42 for use at a later time. Alternatively, the roving 27 may be wound onto a take-up roll 44 for storage for later use, as is depicted in FIG. 2. In either situation, the roving 27 may be processed into molded high performance composite parts.

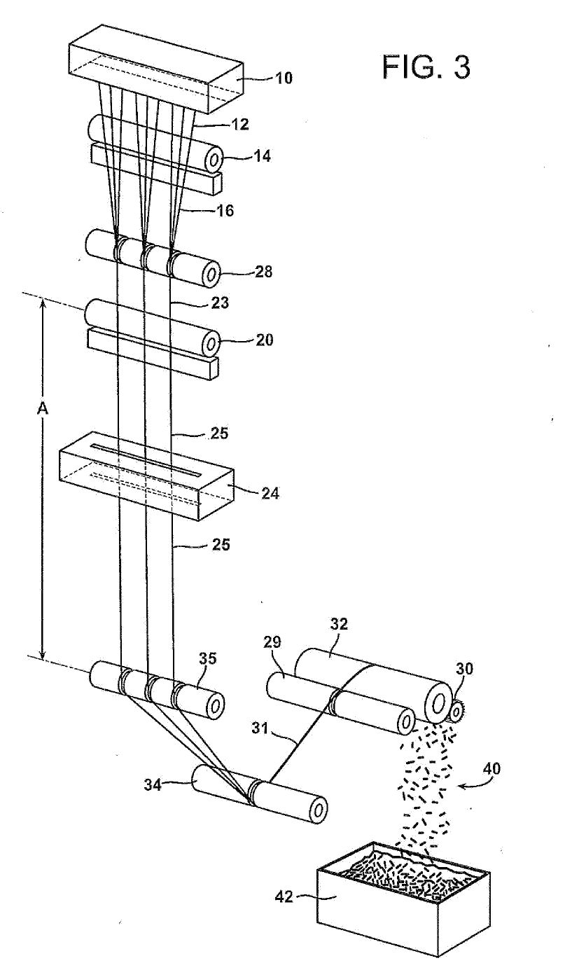

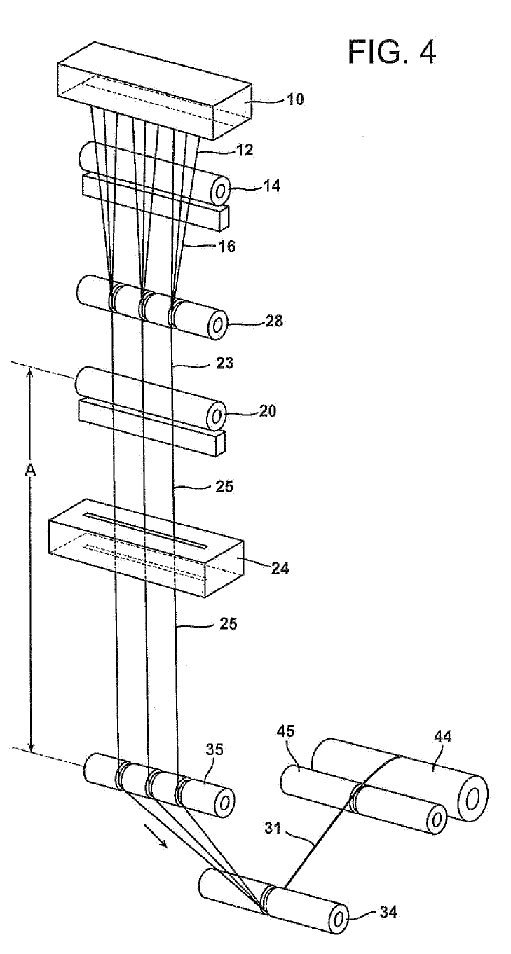

In an alternate embodiment depicted in FIGS. 3 and 4, the glass fibers 12 are split after the size composition is applied thereto and prior to the application of the emulsion or slurry containing the matrix resin. As is shown in FIGS. 3 and 4, the glass fibers 12 are attenuated from a bushing 10 and sized with a suitable sizing applicator 14. The sized fibers 16 are then split into strands 23 by the splitting/gathering device 28. The strands 23 contain a predetermined, desired amount of sized fibers 16, the number of which is determined by the final application and/or product formed. Generally, the strands 23 may contain from about 50 to about 100 sized fibers 16.

The strands 23 are then passed by or through the matrix resin applicator 20, which deposits or otherwise coats an emulsion or slurry that contains a matrix resin onto the strands 23. Like the previous embodiments, the thermoset matrix resin is desirably an epoxy resin and the thermoplastic matrix resin is preferably polypropylene. However, unlike the above-described embodiments, the matrix resin is applied to the strand, not to the individual fibers. As a result, the matrix resin substantially surrounds the external portion of the strand 23, leaving the internal, sized fibers 16 untouched or virtually untouched by the matrix resin and forming composite strand 25. As used herein, the phrase “substantially surrounds” is meant to indicate that the matrix resin surrounds or nearly surrounds the strands 23. A heating apparatus 24 may be positioned between the resin matrix applicator 20 and the guide roll 35 to facilitate the drying of the size composition and matrix resin on the composite strands 25. Similar to the embodiments discussed above, it is desirable that greater than (or equal to) about 99% of the free water (i.e., water that is external to the composite strands 25) is removed, leaving the composite strands 25 with less than about 1% free water. In an exemplary embodiment, substantially all the water is removed from strands 25 before strands 25 touch a contact point.

After traveling a distance (A) such that the sizing composition and matrix resin are dry or substantially dry, the composite strands 25 are pulled by guide roller 34 past roller 35 and formed into a composite roving 31, which may be wound or chopped for later use. It is envisioned that the distance (A) is from the matrix applicator 20 to the guide roller 35 is a distance sufficient to dry the size composition on the fibers to an extent that the composite strands 25 will not stick to guide roller 35. It is estimated that that distance (A) may range from about 20 to about 150 feet, from about 25 to about 100 feet, or from about 50 to about 100 feet. In exemplary embodiments, the distance may be from about 30 to about 70 feet. Ultimately, the distance (A) is dependent on the water contents of the size composition and the matrix resin emulsions or slurries and the type and location of the heating apparatus 24 in the forming line. As depicted in FIG. 3, the roving 31 passes from roller 34 to a guide roller 29 and into a cutting apparatus such as a chopper 30/cot 32 combination where the composite roving 31 is chopped into chopped strand segments 40 having a length from about ¼ to about 2.0 inches, preferably from about ½ to about 1.0 inch. The chopped strand segments 40 are collected in a container 42 for use at a later time. Alternatively, as shown in FIG. 4, the composite roving 31 may be wound onto a take-up roll 44 for storage.

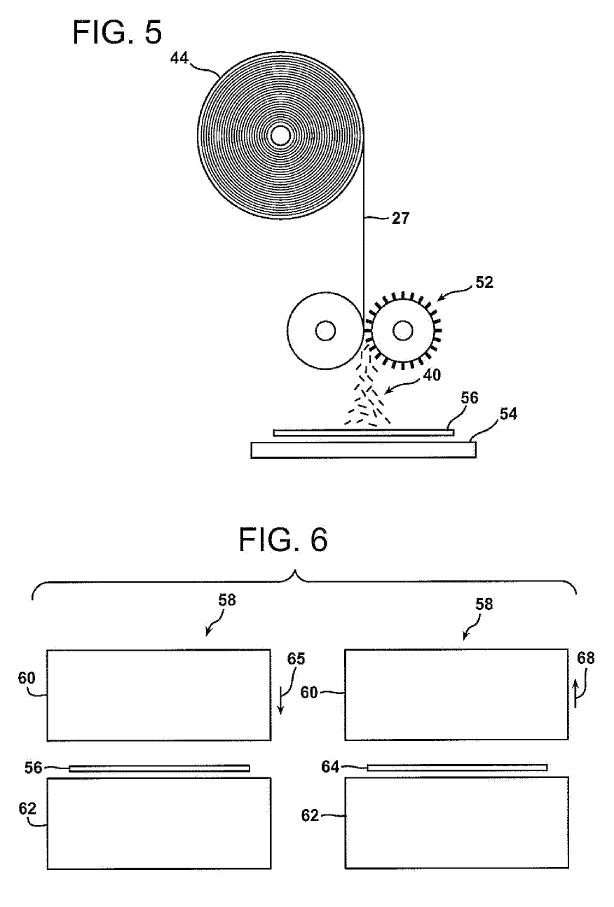

Composite parts may be formed from any of the rovings or chopped strands described above, which, as set forth in detail above, are formed at least partly of a matrix resin. As one example illustrated in FIGS. 5 and 6, a composite roving 27 containing a thermoset resin is unrolled from the take-up roll 44 and passed through a chopping apparatus 52 to form chopped strand segments 40. It is to be appreciated that composite roving 31 may be alternatively used to form the chopped strand segments. The chopped strand segments 40 are deposited onto a preform screen 54 to form a preform 56. Alternatively, the chopped strand segments 40 may be deposited onto the preform screen 54 from the storage container 42 depicted in FIG. 1. A vacuum (not shown) may be used to ensure that the chopped strand segments 40 fall onto the preform screen 54 in a manner consistent with the design of the composite part.

Once the preform 56 is formed, it is placed into a mold 58 having an upper half 60 and lower half 62. The upper half and lower half 60, 62 of the mold 58 is then closed and heated under a desired pressure to form a composite part 64. Preferably, the desired pressure is from about 300 to about 1200 psi. In the embodiment depicted in FIG. 5, the upper half 60 of the mold 58 is lowered in the direction of arrow 65 to close the mold 58 around the preform 56. The closed mold 58 is maintained at an elevated temperature for a period of time to cause the matrix resin to melt, flow, and cure. Once the compression molding process is complete, the upper half of the mold 58 moves in the direction of arrow 68 to open the mold 58 and release the composite part 64. Desirably, the temperature range of the mold is from about 200° F. to about 400° F. It is to be noted that the composite part is molded into the desired shape without the need for the inclusion of any additional resin to the mold (although it is within the purview of the invention to add additional resin before or during the molding process). Indeed, the matrix resin in the composite roving is sufficient to form the molded composite part without any additional resin. Additionally, the composite part contains glass fibers in an amount from about 65 to about 80% by weight of the composite part, preferably from about 70 to about 75% by weight, and most preferably about 75% by weight. Such a high content of glass fibers in the composite part enables the part to be used for high performance parts such as leaf springs, transmission supports, and complex preform parts heretofore impossible to achieve.

On the other hand, if the roving 27 (or roving 31) contains a thermoplastic resin, the mold would typically not be heated. Rather, the mold is either at ambient temperature or cooled to a desired temperature. The preform itself is heated to a temperature sufficient to soften the thermoplastic resin. The heated preform is placed into the mold and the mold is closed. The pressure exerted onto the heated preform by the closed mold causes the thermoplastic resin and the glass fibers to distribute at least substantially evenly throughout the mold. The mold absorbs at least a portion of the heat emanating from the heated resin. As the thermoplastic resin cools, the thermoplastic resin hardens and forms the molded composite part.

One example of utilizing chopped strand segments 40 containing a thermoplastic resin is injection molding. Conventionally, injection molding is a closed-molding process where filled or unfilled polymer resins are injected into closed matched metal molds. In at least one embodiment of the invention, the chopped strand segments 40 containing a thermoplastic resin are placed into a chamber or barrel of an injection molding machine. The chamber (barrel) of the injection molding machine is heated to a temperature sufficient to melt the polymer resin. The melted resin/glass fiber mixture is then injected into a cooled, closed mold. After a sufficient period of time in the mold, the melted resin/glass fiber mixture cools and forms a solid polymeric article in the shape defined by the mold. It is to be appreciated that no additional or separate thermoplastic resin need be added to the injection molding machine as a result of the resin on the inventive composite fibers. It is to be appreciated that, in some instances, it may be desirable to add additional thermoplastic resin to the injection molding machine, depending on the end product and/or its use.

Alternatively, chopped strand segments 40 containing a thermoset resin may be placed into the chamber of an injection molding machine and heated to a temperature sufficient to melt the thermoset resin. Unlike the thermoplastic polymeric articles described above, the formed composite article can be removed hot from the matched molds as a vitrified, solid part due to the curing properties of the thermoset polymer.

Another use for the chopped strand segments 40 is in compression molding a bulk molding compound (BMC). Thus, in at least one aspect of the invention, the chopped fiber segments 40 containing a thermoset resin may be advantageously employed as reinforcements in bulk molding compounds. In operation, a bulk molding compound containing the chopped strand segments may be injected into a heated mold by an injection molding machine to effect crosslinking and cure of the thermoset resin. BMC injection molding is advantageous in that it has a fast cycle time and can mold numerous parts with each injection. Thus, more final parts can be formed with a BMC material and manufacturing times can be increased.

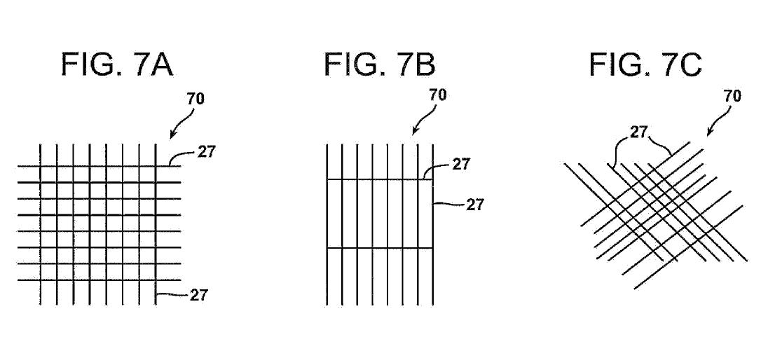

It is also envisioned that the composite roving 27 or 31 of FIGS. 2 and 4, respectively, may be woven, as shown in FIG. 7A, knitted, as shown in FIG. 7B, or braided, as shown in FIG. 7C in a manner known in the fiberglass industry to form a fabric 70. One or more layers of fabric 70 may then be placed in a mold and compression molded as described above in FIG. 6 to form composite parts having a high glass content and good mechanical properties.

There are numerous advantages provided by the present invention. As one advantage, the aesthetic properties of composite parts formed from glass fibers coated with the emulsion containing the matrix resin can be more precisely controlled and enhanced. For example, dyes or colored powders may be added to the emulsion, which is then molded into the final composite part.

Additionally, because the matrix resin is added to the glass fibers, the resin is in close contact to the glass fibers. As a result, the composition of the final composite parts is precisely controlled as compared to other composite systems where the polymer resin material and fibers are separately introduced into an injection mold or similar apparatus. As a result, structural and mechanical properties of the final composite parts may be more precisely controlled from part to part. Further, the pre-combination of the glass and the matrix resin enables the composite roving to act like a prepeg.

In addition, problems inherent with processing and manufacturing composite parts with high fiber content are eliminated in the present invention. As discussed above, it is difficult to introduce a high fiber content into injection molding processes. Therefore, the amount of fiber content that may be loaded within the composite part is controlled by the desired mechanical properties, not by the inherent problems with the process itself. Because polymer resins are more typically more expensive than the fiber reinforcement material (e.g., glass fibers), the cost of the composite part is correspondingly decreased as more fiber is introduced. According to the present invention, composite parts having a glass content from about 65 to about 80% by weight may be achieved. Additionally, the volatile organic content (VOC) that may be released into the atmosphere during the processing steps is minimal.

Further, cost savings both in terms of manufacturing costs and raw material costs are achieved by the instant invention. As one example, unlike conventional molding processes in which the resin and glass fibers are separately added, the matrix resin is present on the glass fibers. By placing the matrix resin on the glass (or other reinforcement) fiber, the compounding or pre-mixing step is eliminated and the manufacturing costs are reduced. Individually introducing the reinforcement fibers and the resin adds to the overall manufacturing costs.

Having generally described this invention, a further understanding can be obtained by reference to certain specific examples illustrated below which are provided for purposes of illustration only and are not intended to be all inclusive or limiting unless otherwise specified.

Having thus described the invention, what is claimed is:

1. An in-line method of making a composite roving for use in making structural composites comprising:
applying a size composition to a plurality of reinforcement fibers to form sized reinforcement fibers;
applying at least one matrix resin to said sized reinforcement fibers to form composite fibers, said matrix resin being selected from a thermoplastic resin powder, a thermoplastic resin emulsion, a thermoset resin powder and a thermoset resin emulsion;
drying said composite fibers by permitting said composite fibers to travel a distance sufficient to dry said composite fibers and form dried composite fibers; and
gathering said dried composite fibers into a composite roving.

2. The method of claim 1, wherein said applying step comprises:
applying said size composition to a plurality of attenuated glass fibers to form sized glass fibers.

3. The method of claim 1, wherein said drying step comprises:
permitting said composite fibers to travel a distance sufficient to air dry said composite fibers, said dried composite fibers containing less than about 1% free water.

4. The method of claim 1, wherein a heating apparatus is utilized to assist in drying said composite fibers and form dried composite fibers.

5. The method of claim 1, wherein said distance is from about 20 to about 150 feet.

6. The method of claim 1, wherein said at least one matrix resin is applied to said sized reinforcement fibers in an amount from about 20 to about 35% by weight of said composite roving.

7. The method of claim 1, further comprising chopping said composite roving to form chopped strand segments, said chopped strand segments having a discrete length.

8. The method of claim 1, further comprising:
cooling said composite fibers subsequent to said drying step prior to touching a contact point.

9. A one step, in-line method of forming a high performance composite roving comprising:
applying a size composition to a plurality of attenuated glass fibers to form sized glass fibers;
gathering said sized glass fibers into a plurality of strands;
applying at least one matrix resin to said plurality of strands to form a plurality of composite strands, said matrix resin being selected from a thermoplastic resin powder, a thermoplastic resin emulsion, a thermoset resin powder and a thermoset resin emulsion;
permitting said plurality of composite strands to travel a distance sufficient to dry said size composition and said at least one matrix resin; and
gathering said plurality of dried composite strands into a composite roving.

10. The method of claim 9, wherein said at least one matrix resin is applied to said plurality of strands in an amount from about 20 to about 35% by weight of said composite roving.

11. The method of claim 9, wherein said distance is from about 20 to about 150 feet.

12. The method of claim 9, further comprising chopping said composite roving to form chopped strand segments, said chopped strand segments having a discrete length.

13. The method of claim 9, wherein a heating apparatus assists in drying said plurality of composite strands to form a plurality of dried composite strands.

14. A method of forming a composite part comprising:
applying a size composition to attenuated glass fibers to form sized glass fibers;
applying at least one matrix resin to said sized glass fibers to form composite fibers, said matrix resin being selected from a thermoplastic resin powder, a thermoplastic resin emulsion, a thermoset resin powder and a thermoset resin emulsion;
permitting said composite fibers to travel a distance sufficient to dry said composite fibers;
gathering said dried composite fibers into a composite roving;
chopping said composite roving into chopped strand segments having a discrete length; and
molding said chopped strand segments into a structural composite having a desired shape in a mold without adding any additional resin to said mold.

15. The method of claim 14, wherein a heating apparatus is utilized to assist in drying said composite fibers and form dried composite fibers.

16. The method of claim 15, wherein said at least one matrix resin is applied to said sized glass fibers in an amount from about 20 to about 35% by weight of said composite roving, and
wherein said structural composite contains said glass fibers in an amount from about 65 to about 80% by weight of said composite part.

17. The method of claim 16, wherein said distance is from about 20 to about 150 feet.

18. A method of forming a composite part comprising:
applying a size composition to a plurality of attenuated glass fibers to form sized glass fibers;
gathering said sized glass fibers into a plurality of strands;
applying at least one matrix resin to said plurality of strands to form a composite strand, said matrix resin being selected from a thermoplastic resin powder, a thermoplastic resin emulsion, a thermoset resin powder and a thermoset resin emulsion;
permitting said plurality of composite strands to travel a distance sufficient to dry said size composition and said matrix resin;
gathering said plurality of dried composite strands into a composite roving;
chopping said composite roving into chopped strand segments having a discrete length; and
molding said chopped strand segments into a structural composite having a desired shape in a mold without adding any additional resin to said mold.

19. The method of claim 18, wherein said at least one matrix resin is applied to said sized glass fibers in an amount from about 20 to about 35% by weight of said composite roving, and
wherein said structural composite contains said glass fibers in an amount from about 65 to about 80% by weight of said composite part.

20. The method of claim 19, wherein said distance is from about 20 to about 150 feet.

21. The method of claim 18, wherein a heating apparatus is utilized to assist in drying said composite strands and form dried composite strands.
